(19) United States
(12) Patent Application Publication
(10) Pub. No.: US 2016/0186692 A1
(43) Pub. Date: Jun. 30, 2016

(54) CARBURETOR

(71) Applicant: ZAMA JAPAN KABUSHIKI KAISHA, Iwate (JP)

(72) Inventor: Daisuke Suzuki, Morioka (JP)

(21) Appl. No.: 14/942,245

(22) Filed: Nov. 16, 2015

(30) Foreign Application Priority Data
Nov. 25, 2014 (JP) 2014-238209

(51) Int. Cl. F02M 9/10

(52) U.S. Cl. CPC F02M 9/103

(57) ABSTRACT

A carburetor provided with a cap that prevents removal thereof by willful and forcible over-operation or destruction by a user, that is easily assembled without increasing the number of components, and that is a control means of an adjustment valve of a fuel flow rate concomitant to a carburetor of a conventional utility engine. A sleeve 2 extends from or is integrally connected to a carburetor main body 1 and is disposed to surround the limit caps 6, 7, includes spaces 23, 24 for rotating arm pieces 611, 711 attached to the limit caps 6, 7.

### FIELD

The present invention relates to a carburetor suited to supply fuel to a utility engine used as a power source of a machine for farming or gardening or the like, wherein the carburetor has a fuel adjustment function that enables manual adjustment of a fuel flow rate.

### BACKGROUND

A carburetor that supplies fuel to a utility engine has a considerably small fuel flow rate compared to a carburetor that supplies fuel to a four-cycle engine such as an automotive engine. Because a fluctuation ratio of the fuel flow rate is large due to deviations in a position and dimensions of each portion or differences in quality of components and because there are performance differences between individual engines receiving the fuel supply, there is a need to individually adjust the fuel flow rate in such carburetors.

Because of this, a manual adjustment valve, which includes a needle-shaped valve body that is inserted into a fuel channel and continuously changes an effective surface area thereof, a screw portion that screws into a carburetor main body and causes the valve body to move back and forth while turning, and a head portion that is exposed outside of the carburetor main body for turning the screw portion, is provided in a main fuel channel and a low-speed fuel channel, respectively, to be able to individually adjust the fuel flow rate.

This adjustment valve is fundamentally supplied to a general user in a state where a manufacturer of the carburetor and the engine, or a manufacturer of a machine or the like that incorporates the carburetor and the engine, performs an operation to make an adjustment to an optimal fuel flow rate. The user, however, sometimes performs operations in an attempt to maintain performance against a change in location or condition of use, for example, a change in air pressure, or performs an operation intending to improve a temporary malfunction of the engine or to further improve the performance, which can generate trouble such as output reduction, exhaust state worsening, and engine stopping as a result of making an air-fuel mixture too concentrated or too thin.

Meanwhile, in recent years, exhaust regulations are beginning to be implemented in utility engines as well, and because of this, there is a demand for providing a limiting means whereby the user can only adjust the adjustment valve adjusted by the manufacturer within an exhaust regulation compliance range and a demand for making this limiting means be of a structure that is not easily removable.

Limiting means that prevents the adjustment valve from being operated beyond a certain point have been proposed that include: mounting a cap having an arm piece protruding in a radial direction on a head portion of an adjustment valve so the arm piece contacting a carburetor main body, which is a stopper, limits the operation to no more than one rotation (for example, see Japanese Examined Patent Application Publication No. S47-42424, U.S. Pat. No. 3,618,906); and, bringing near each other and disposing parallel to each other adjustment valves of a main fuel channel and a low-speed fuel channel and limiting the operations thereof to no more than one rotation by an arm piece contacting the other adjustment valve, which is a stopper, or a cap thereof (for example, see Japanese Unexamined Utility Model (Registration) Application Publication No. S61-134555, U.S. Pat. No. 5,236,634).

These limiting means are temporarily mounted on the head portion to an extent where they will not fall off before adjustment by the manufacturer and actually mounted in a position where the arm piece contacts the stopper after adjustment is finished or are not temporarily mounted but mounted in the position where the arm piece contacts the stopper after adjustment by the manufacturer. Therefore, extremely small components must be handled by being individually pinched by fingers, which is not only cumbersome but also causes variation in the mounting phase, widening a unidirectional operable range of the arm piece until it contacts the stopper. Because of this, there is concern that the air-fuel mixture will be concentrated or thinned in excess of the exhaust regulation compliance range.

Furthermore, because these limiting means are made to be in a state of being exposed on the exterior of a carburetor main body, they can be easily removed by using a simple tool and are not able to prevent willful and forcible over-operation by the user.

Therefore, a concept has also been proposed that fixes a lid body (holding plate) that can contact a head portion of the cap or an arm piece concomitant to the cap, which is a limiting means, in a position opposite a carburetor main body and interposing a cap with an object preventing removal of the cap (for example, see Japanese Patent Application Publication No. H8-312465).

However, positioning the lid body requires using a means such as welding, adhesion, or screwing for fixing to the carburetor main body, and this not only increases number of components due to separately preparing the lid body but also causes laborious assembly.

Furthermore, the cap, which is a control means, generally uses plastic. In this configuration, however, there is a problem where removal thereof by willful and forcible destruction by the user cannot be prevented.

Therefore, to prevent removal by destruction, a concept has also been proposed where a cap made of metal is used (for example, see Japanese Patent Application Publication No. 2009-138652).

However, in a configuration where the cap made of metal is used, because an adjustment valve is also generally made of metal, there is a need in the metals for a mating using a serration or a spline. It is thereby anticipated that when a load is applied in a direction of the cap or the adjustment valve when the two are mated, the load may cause misalignment of the adjustment valve, the cap may not be pushed in sufficiently to a regulated position as designed, or the like.

Therefore, a concept has also been proposed that uses plastic for a portion that mates with an adjustment valve of a cap and uses metal for a surface portion of the cap to prevent destruction (for example, U.S. Pat. No. 8,544,829).

However, in the concept according to U.S. Pat. No. 8,544,829, as illustrated in FIG. 10, a configuration is such that a base end portion part 4a of a cap 3a is mounted to mate with a serration 2a of an adjustment valve 1a and a tip portion part 5a is disposed thereon to cover these components. Another adjustment valve or cap cannot be disposed in a position interfering with an outer diameter of the tip portion part 5a, which is necessarily positioned on the outermost periphery.

That is, in configuration where an adjustment valve is provided on a main fuel channel and a low-speed fuel channel, respectively, and the adjustment valves are disposed near each other, a configuration can also be anticipated where the application of the cap 3a that is the invention according to U.S. Pat. No. 8,544,829 is difficult because the cap 3a needs to be a certain size.

### SUMMARY

### Technical Problem

The present embodiments have as an object to provide a carburetor provided with a cap that prevents removal thereof by willful and forcible over-operation or destruction by a user, can be easily assembled without increasing the number of components, and is a control means for an adjustment valve of a fuel flow rate concomitant to a carburetor of a conventional utility engine.

### Solution to Problem

To solve the above object, the present embodiments are provided with a sleeve that extends from or is integrally connected to a carburetor main body and is disposed to surround the cap and a space within the sleeve for rotating an arm piece attached to the cap.

That is, by providing the space for rotating the arm piece in the sleeve in the carburetor in advance by any processing means at a manufacturing step, generation of additional components is prevented, an assembly procedure is not greatly changed from a conventional one, and, in such embodiment, removal of the cap disposed in the sleeve by a willful and forcible destructive act by the user is made extremely difficult.

Furthermore, in the present embodiments, the cap includes a tip portion and a base end portion that may be integrally formed, or may be formed as separate bodies. In the integral configuration a material may be selected from any one material from among a plastic, a metal, or the like. However, in the separate bodies configuration, a combination of different types of materials, such as making the tip portion from a metal and the base end portion from a plastic, is also possible. In such a configuration, a superior interaction can be exhibited by applying a combination that takes advantage of the properties of the materials.

### Advantageous Effects of Invention

According to the present embodiments, in the carburetor that is configured to supply fuel to a utility engine and has an adjustment valve of a fuel flow rate and a control means of this adjustment valve, generation of the additional components is prevented, the assembly procedure is not greatly changed from the conventional one, and, in the embodiment, removal of the cap disposed in the sleeve by the willful and forcible destructive act by the user is made extremely difficult.

### BRIEF DESCRIPTION OF DRAWINGS

FIGS. 1(a) and (b) are explanatory views of a preferred embodiment of the present invention. FIG. 1(a) illustrates a first state, which is an adjustment position, and FIG. 1(b) illustrates a second state, which is a final position.

FIGS. 2(a) and (b) are explanatory views representing states of a sleeve and each limit cap in the preferred embodiment of the present invention illustrated in FIG. 1: (a) illustrates the first state, which is the adjustment position, and (b) illustrates the second state, which is the final position.

FIGS. 3(a), (b) and (c) are explanatory views illustrating a rotatable range of each limit cap in the sleeve in the preferred embodiment of the present invention illustrated in FIG. 1. FIG. 3(a) illustrates a configuration where a high speed-side adjustment valve is disposed in a state of being able to rotate only in a reducing direction of a fuel flow rate, FIG. 3(b) illustrates a configuration where the high speed-side adjustment valve is disposed in a state of being able to rotate only in an increasing direction of the fuel flow rate, and FIG. 3(c) illustrates a configuration where the high speed-side adjustment valve is disposed in a state of being able to rotate in both the increasing direction and the reducing direction of the fuel flow rate.

FIG. 4(a) is a perspective view illustrating another component that can be used in place of a high speed-side limit cap and a low speed-side limit cap in a different embodiment of the present invention.

FIG. 4(b) is a perspective view illustrating an adjustment valve where a shape of a portion thereof is different in a different embodiment of the present invention.

FIGS. 5(a) and (b) are perspective views illustrating the high speed-side limit cap and the low speed-side limit cap in the preferred embodiment of the present invention illustrated in FIG. 1. FIG. 5(a) illustrates the high speed-side limit cap, and FIG. 5(b) illustrates the low speed-side limit cap.

FIGS. 6(a) and (b) are horizontal cross-sectional views illustrating the high speed-side limit cap and the low speed-side limit cap in the preferred embodiment of the present invention illustrated in FIG. 1. FIG. 6(a) illustrates the high speed-side limit cap, and FIG. 6 (b) illustrates the low speed-side limit cap.

FIGS. 7(a) and (b) are perspective views illustrating the high speed-side adjustment valve and a low speed-side adjustment valve in the preferred embodiment of the present invention illustrated in FIG. 1. FIG. 7(a) illustrates the high speed-side adjustment valve, and FIG. 7(b) illustrates the low speed-side adjustment valve.

FIG. 8 is a perspective view illustrating a carburetor in the preferred embodiment of the present invention illustrated in FIG. 1.

FIGS. 9(a) and (b) are fragmentary cross-sectional views representing a structure of the carburetor in the preferred embodiment of the present invention illustrated in FIG. 8. FIG. 9(a) is a partial cross-sectional view along plane A illustrated in FIG. 8, and FIG. 9(b) is a partial cross-sectional view along plane B illustrated in FIG. 8.

FIG. 10 is an explanatory view illustrating a conventional example described in U.S. Pat. No. 8,544,829.

### DESCRIPTION OF EMBODIMENTS

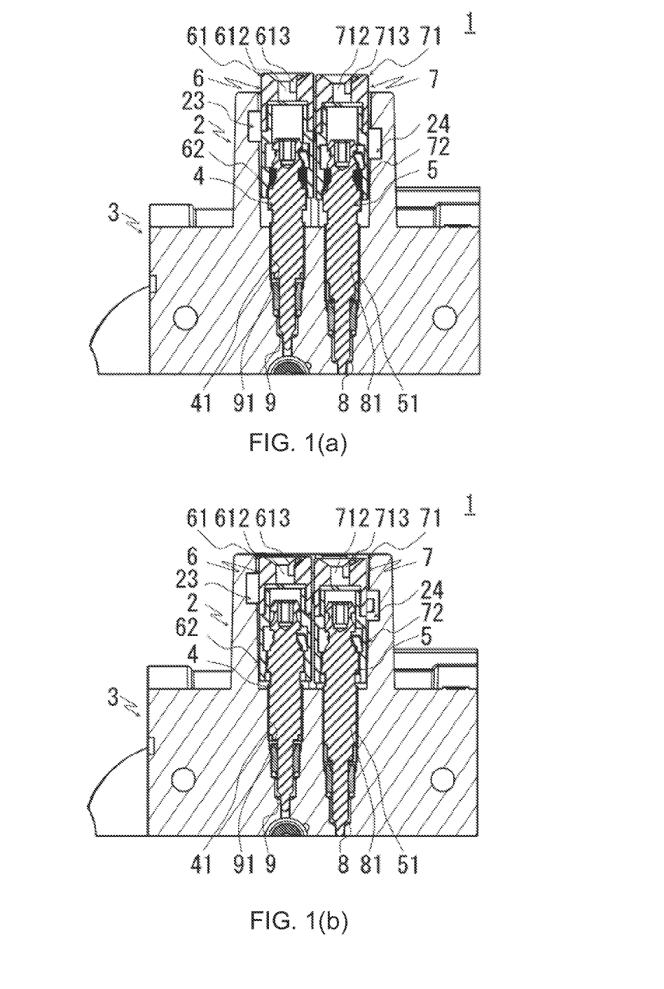

FIGS. 1 to 9 illustrate a preferred embodiment of the present invention, and this embodiment will be described below with reference to the drawings.

FIGS. 1(a) and (b) are explanatory views of the embodiment of the present invention and represents a high speed-side adjustment valve 4 and a low speed-side adjustment valve 5 screwed into a main body 3 of a carburetor 1, and a high speed-side limit cap 6 and a low speed-side limit cap 7 connected so each adjustment valve 4, 5 and disposed in a sleeve 2 extending from or integrally connected to the carburetor main body 3.

Here, FIGS. 1(a) and 1(b) depict a procedure of adjusting each adjustment valve 4, 5 to an optimal fuel flow rate and positioning each limit cap 6, 7 in a position of a second state, which is a final position. A detailed description thereof will be given below. While a length in an axial direction of a portion of the components of the high speed-side adjustment valve 4 and the low speed-side adjustment valve 5 differ, the function is the same. Similarly, with the high speed-side limit cap 6 and the low speed-side limit cap 7, a disposition position of a portion of the components of the high speed-side limit cap 6 and the low speed-side limit cap 7 differs, they function the same. As a result, a description will be given with reference to the high speed-side adjustment valve 4 and the high speed-side limit cap 6.

That is, the low speed-side adjustment valve 5 and the low speed-side limit cap 7 are operated in a similar procedure to the high speed-side adjustment valve 4 and the high speed-side limit cap 6, and description thereof will be omitted.

FIG. 1(a) illustrates a first state, which is an adjustment position, where the high speed-side limit cap 6 is inserted onto the high speed-side adjustment valve 4 and a first step 43 of the high speed-side adjustment valve 4 abuts an axial direction disengagement prevention portion 621 of the high speed-side limit cap 6.

To describe in further detail, an appropriate tool is engaged in an adjustment polygonal hole 421 provided in a first step portion 42 that is a head portion of the high speed-side adjustment valve 4. A screw portion 41 of the high speed-side adjustment valve 4 is screwed operation of this tool to a high speed-side adjustment hole 91 communicated to a high speed-side fuel channel 9 provided in the carburetor main body 3. The position of the high speed-side limit cap 6 is thereafter aligned so an arm piece 611 of the high speed-side limit cap 6 passes through a high speed-side limit cap positioning groove 21 provided in the sleeve 2, and the high speed-side limit cap 6 is inserted onto the high speed-side adjustment valve 4. Represented is the first state, where, at this time, the axial direction disengagement prevention portion 621 on the high speed-side limit cap 6 is on the first step 43 corresponding to a middle portion of the first step portion 42 and a second step portion 44 of the high speed-side adjustment valve 4.

In this first state, because a cap-side locking portion 623 provided on the high speed-side limit cap 6 and a valve-side locking portion 47 provided on the high speed-side adjustment valve 4 are not mated, by passing the tool through through-holes 612, 622 provided in the high speed-side limit cap 6 and by engaging operating the tool in the adjustment polygonal hole 421 provided in the first step portion 42 that is the head portion of the high speed-side adjustment valve 4, the high speed-side adjustment valve 4 can be freely rotated. Because of this, in the first state, a manufacturer can adjust the high speed-side adjustment valve 4 to the optimal fuel flow rate.

Here, needless to say, the manufacturer can select according to their discretion the procedure to be one where after first inserting onto the axial direction disengagement prevention portion 621 of the high speed-side limit cap tithe high speed-side adjustment valve 4 to the position of the first step 43; the position of the high speed-side limit cap 6 is aligned so the arm piece 611 passes through the high speed-side limit cap positioning groove 21 provided in the sleeve 2. The appropriate tool is engaged in the adjustment polygonal hole 421 by passing through the through holes 612, 622. By the operation of the tool, the screw portion 41 of the high speed-side adjustment valve 4 is screwed into the high speed-side adjustment hole 91 communicated to the high speed-side fuel channel 9 provided in the carburetor main body 3.

Furthermore, in this first state, because the high speed-side limit cap 6 has the arm piece 611 engaged in the high speed-side limit cap positioning groove 21, adjustment of the high speed-side adjustment valve 4 can be performed without rotating the high speed-side limit cap 6, and the high speed limit cap 6 can be pushed down without vibrating when moving to the second state, as described below, which is highly convenient.

FIG. 1(b) illustrates the second state, which is the final position, where the high speed-side limit cap 6 is further pushed down toward the adjusted high speed-side adjustment valve 4, a second step 45 of the high speed-side adjustment valve 4 abuts the axial direction disengagement prevention portion 621 of the high speed-side limit cap 6, and the valve-side locking portion 47 of the high speed-side adjustment valve 4 is mated with the cap-side locking portion 623 of the high speed-side limit cap 6.

In this second state, because the high speed-side limit cap 6 and the high speed-side adjustment valve 4 integrally rotate due to the valve-side locking portion 47 and the cap-side locking portion 623 being mated, it is also possible to adjust the high speed-side adjustment valve 4 using the adjustment polygonal hole 421 and to adjust the high speed-side adjustment valve 4 using a user adjustment hole 613 provided in the high speed-side limit cap 6. However, with both, no change arises in an operating range of the high speed-side adjustment valve 4.

Because of this, when the user is performing adjustment of the fuel flow rate by hand, it becomes possible to do so using the user adjustment hole 613.

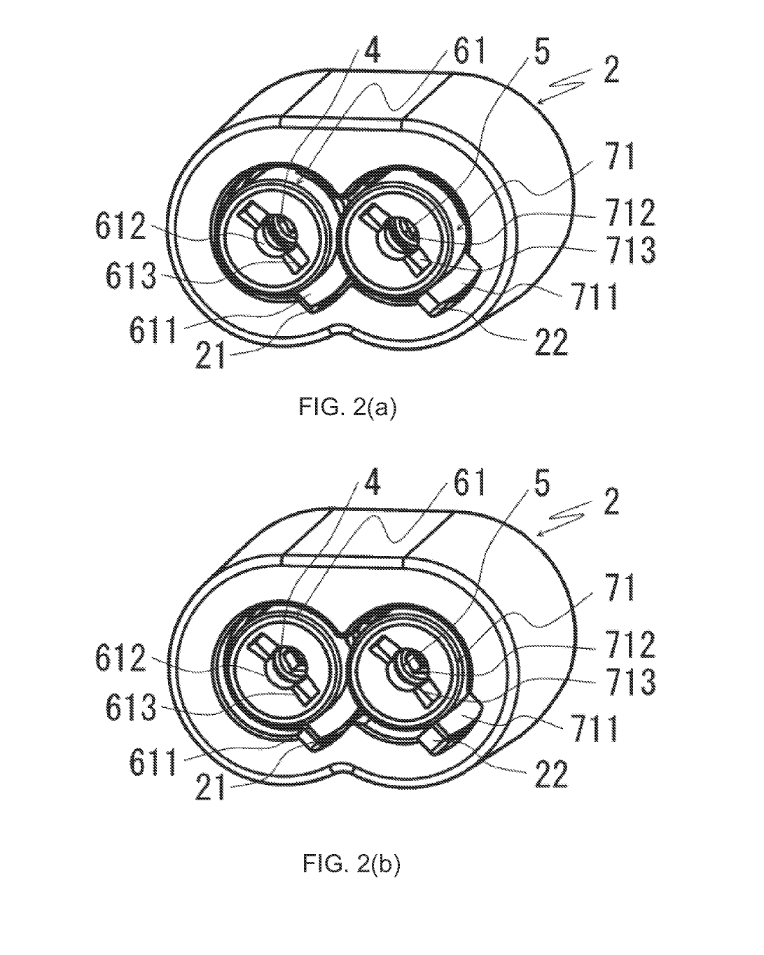

FIG. 2 illustrates structures of the sleeve 2 that is extended from the carburetor 1 or formed as a separate body from the carburetor 1 but integrally connected thereto. A high speed-side rotation space 23 and a low speed-side rotation space 24 for rotating each arm piece 611, 711 are provided in the sleeve 2 in advance by any processing means or at a manufacturing step. The high speed-side limit cap positioning groove 21 and a low speed-side limit cap positioning groove 22 are provided in communication with each rotation space 23, 24. FIG. 2(a) is a view where each limit cap 6, 7 is inserted to the position of the first state so each arm piece 611, 711 passes through each positioning groove 21, 22. FIG. 2(b) a view where each limit cap 6, 7 is further pushed down to be inserted to the position of the second state.

Note that detailed description of the first state and the second state should be referred to in the above.

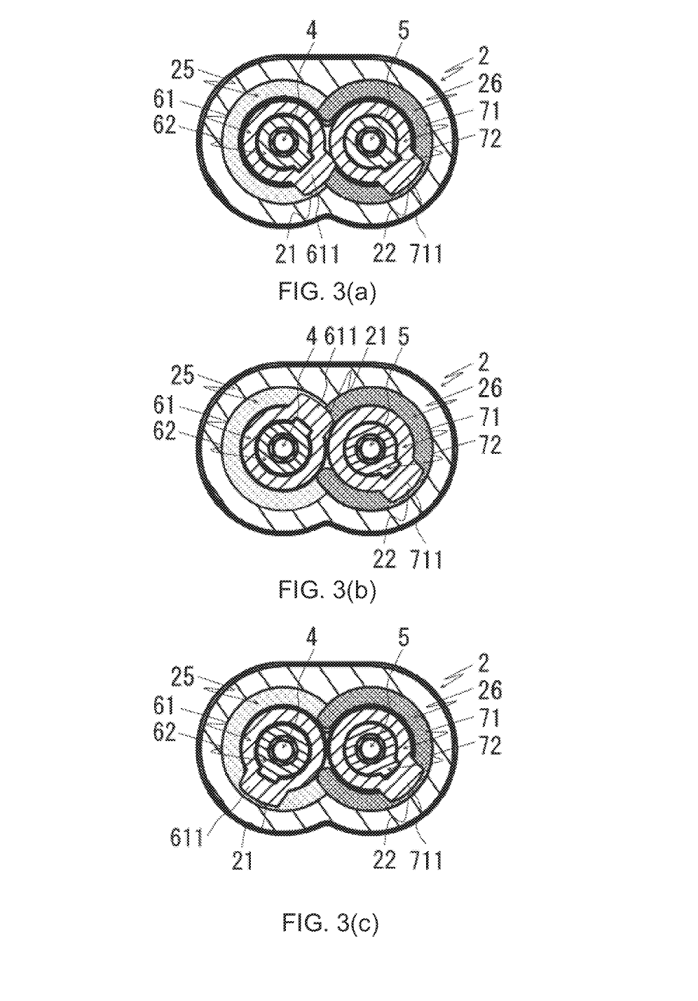

FIG. 3 is an explanatory view illustrating in the second state a rotatable range 25 in which the high speed-side limit cap 6 can rotate and a rotatable range 26 in which the low speed-side limit cap 7 can rotate in the high speed-side rotation space 23 and the low speed-side rotation space 24.

Here, the fuel flow rate of the high speed-side fuel channel 8 being able to be adjusted by rotating the high speed-side limit cap 6 integrally connected to the high speed-side adjustment valve 4 is as described above. The manufacturer is free to select to manifest an effect where in the second state the rotation range is limited by the arm piece 611 contacting a side surface of the low speed-side limit cap 7 so the high speed-side adjustment valve 4 is disposed in a state of being able to be rotated only in a reducing direction of the fuel flow rate (FIG. 3(a)), disposed in a state of being able to be rotated only in an increasing direction of the fuel flow rate (FIG. 3(b)), or disposed in a state of being able to be rotated in both the increasing direction and the reducing direction of the fuel flow rate (FIG. 3(c)).

At this time, a means of selecting the rotatable direction can be realized by changing a position where the high speed-side limit cap positioning groove 21 is provided in the sleeve 2.

Furthermore, similarly, with the low speed-side adjustment valve 5, it is possible to select the rotatable direction of the low speed-side adjustment valve 5 by changing the position where the low speed-side limit cap positioning groove 22 is provided in the sleeve 2.

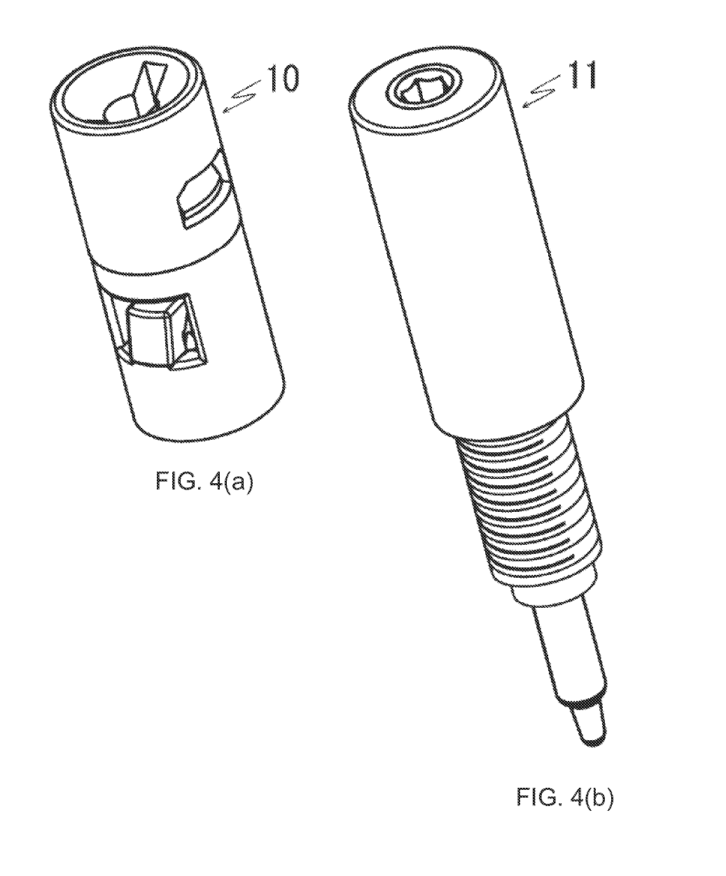

Note that here, in a configuration where the low speed-side limit cap 7 is not used but replaced with another component 10 having substantially the same outer diameter (FIG. 4(a)) or in a configuration where the low speed-side limit cap 7 is not used but at least a portion of an outer diameter more on an end-portion side opposite a screw portion 51 of the low speed-side adjustment valve 5 has substantially the same outer diameter as the low speed-side limit cap 7 (an adjustment valve 11 illustrated in FIG. 4(b) where a shape of a portion is different), the arm piece 611 contacts the other component 10 or the adjustment valve 11 to exhibit the function of limiting the rotation range similarly to the configuration where the low speed-side limit cap 7 is used.

Furthermore, the fuel flow rate of the low speed-side fuel channel 8 can be adjusted by rotating the low speed-side limit cap 7, but a mechanism is such that at this time, the adjustment range of the fuel flow rate of the low speed-side fuel channel 8 is limited by the arm piece 711 contacting a side surface of the high speed-side limit cap 6 in the second state.

Similarly in this configuration, in a configuration where the high speed-side limit cap 6 is not used but replaced with the other component 10 having substantially the same outer diameter (FIG. 4(a)) or in a configuration where the high speed-side limit cap 6 is not used but at least a portion of an outer diameter more on an end-portion side than the screw portion 41 of the high speed-side adjustment valve 4 has substantially the same outer diameter as the high speed-side limit cap 6 (the adjustment valve 11 illustrated in FIG. 4(b) where the shape of a portion is different), the arm piece 711 contacts the other component 10 or the adjustment valve 11 to exhibit the function of limiting the rotation range similarly to the configuration where the high speed-side limit cap 6 is used.

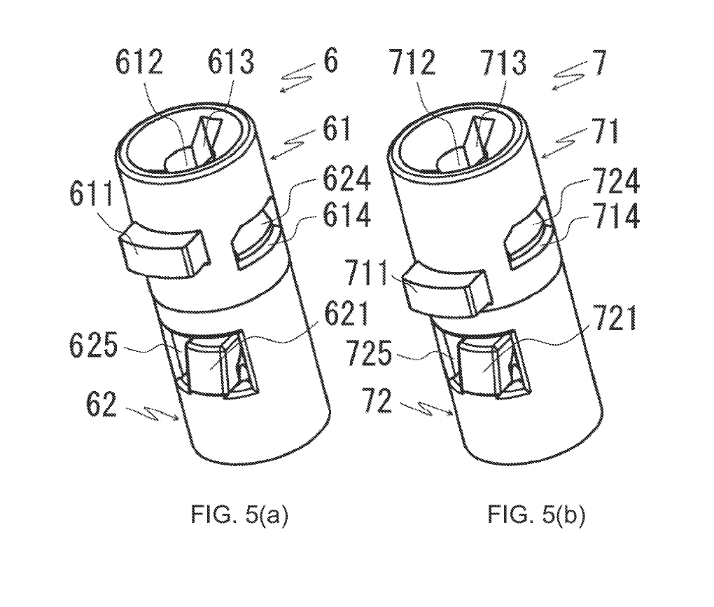

FIGS. 5(a) and (b) are perspective views of the high speed-side limit cap 6 and the low speed-side limit cap 7 in the embodiment of the present invention. FIG. 5(a) illustrates the high speed-side limit cap 6, and FIG. 5(b) illustrates the low speed-side limit cap 7.

FIG. 5(a) illustrates that the high speed-side limit cap 6 is of a structure made from a tip portion 61 and a base end portion 62, and FIG. 5(b) illustrates that the low speed-side limit cap 7 is of a structure made from a tip portion 71 and a base end portion 72.

Here, the tip portion 61 and the base end portion 62 configuring the high speed-side limit cap 6 illustrated in FIG. 5(a) will be described. Because the tip portion 71 and the base end portion 72 configuring the low speed-side limit cap 7 illustrated in FIG. 5(b) have the same shape as the high speed-side limit cap 6 other than the position of the arm piece 711 differing from that of the arm piece 611, a description thereof will be omitted.

The tip portion 61 has the arm piece 611 provided in a protruding manner to limit the rotation range of the high speed-side limit cap 6 by contacting the other component, the through hole 612 for passing the tool through and performing adjustment of the high speed-side adjustment valve 4, the user adjustment hole 613 the user uses to perform adjustment of the high speed-side adjustment valve, and a window hole 614 for inserting a flange 624 of the base end portion 62 to connect for integral movement and rotation of the tip portion 61 and the base end portion 62 in the axial direction and circumferential direction.

The base end portion 62 includes the axial direction disengagement prevention portion 621 whose object is to prevent movement of the high speed-side limit cap 6 in the axial direction at each step, and in particular, disengagement of the high speed-side limit cap 6, by mating with the first step 43 and the second step 45 of the high speed-side adjustment valve 4; the through hole 622 provided with a function similar to that of the through hole 612 of the tip portion 61; the cap-side locking portion 623 that is mated with the valve-side locking portion 47 of the high speed-side adjustment valve 4, and is for integrally rotating around an axis of the high speed-side adjustment valve 4; the flange 624 for inserting into the window hole 614; and an opening portion 625 formed in a periphery of the axial direction disengagement prevention portion 621.

When combining the axial direction disengagement prevention portion 621 to the high speed-side adjustment valve 4, that is, when entering the first state and the second state in the embodiment of the present invention, there is a need for the first step portion 42 and the second step portion 44 to pass through the axial direction disengagement prevention portion 621, and a force is therefore applied from an axial direction to a radial direction of the axial direction disengagement prevention portion 621. However, because the opening portion 625 is formed in the periphery of the axial direction disengagement prevention portion 621, a stress applied on the axial direction disengagement prevention portion 621 is released.

The tip portion 61 and the base end portion 62 may use metal, plastic, or another material as a forming material thereof, and this can be freely selected by the manufacturer.

In the embodiment of the present invention, making the tip portion 61 from metal and making the base end portion 62 from plastic is particularly desirable because by doing so, willful destruction by the user of the tip portion 61 can be prevented, a durability of the user adjustment hole 613 used when the user performs the operation can be increased, and, due to the properties of plastic, misalignment of the high speed-side adjustment valve 4 is mitigated by reducing the load necessary when the manufacturer orients the high speed-side limit cap 6 toward the adjusted high speed-side adjustment valve 4 and pushes it to the position of the second state, or final position.

As described above, the embodiment of the present invention illustrates a structure where the high speed-side limit cap 6 is made from the tip portion 61 and the base end portion 62 and the low speed-side limit cap 7 is made from the tip portion 71 and the base end portion 72. However, these may be respectively integrated to form the high speed-side limit cap 6 and the low speed-side limit cap 7.

Because in this configuration the flange 624 and the window hole 614 are unnecessary, there is a need to suitably change a shape of each portion in the design, but the main functions do not change from those configured as separate bodies.

Furthermore, with the materials as well, similarly to the configuration of configuring as separate bodies, the forming material may be metal, plastic, or another material, and this can be freely selected by the manufacturer.

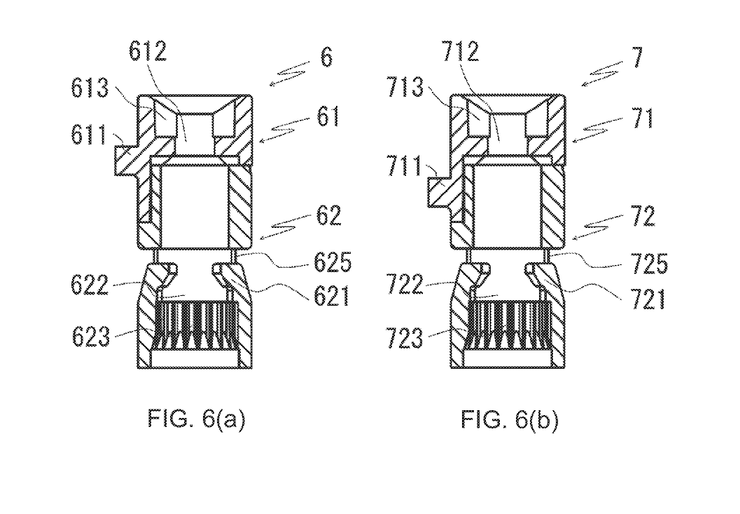

FIGS. 6(a) and (b) are cross-sectional views of the high speed-side limit cap 6 and the low speed-side limit cap 7 in the embodiment of the present invention. FIG. 6(a) illustrates the high speed-side limit cap 6, and FIG. 6(b) illustrates the low speed-side limit cap 7.

FIG. 6(a) illustrates that the high speed-side limit cap 6 is of constructed from the tip portion 61 and the base end portion 62. The cap-side locking portion 623 is positioned on an inner peripheral surface of the base end portion 62. FIG. 6(b) illustrates that the low speed-side limit cap 7 is of the structure made from the tip portion 71 and the base end portion 72. A cap-side locking portion 723 is had on an inner peripheral surface of the base end portion 72.

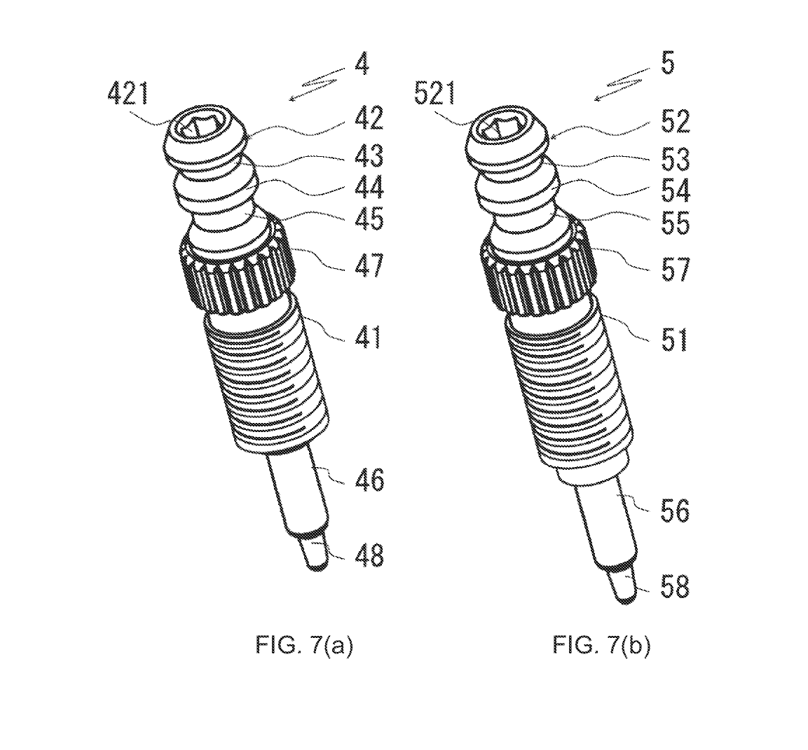

FIGS. 7(a) and (b) are perspective views of the high speed-side adjustment valve 4 and the low speed-side adjustment valve 5 in the embodiment of the present invention. FIG. 7(a) illustrates the high speed-side adjustment valve 4, and FIG. 7(b) illustrates the low speed-side adjustment valve 5.

Here, the high speed-side adjustment valve 4 illustrated in FIG. 7(a) will be described. Because the function of the low speed-side adjustment valve 5 illustrated in FIG. 7(b) is the same as that of the high speed-side adjustment valve 4 even though the length in the axial direction of a portion of the components differs, description thereof will be omitted.

The high speed-side adjustment valve 4 includes the screw portion 41 that screws into the high speed-side adjustment hole 91 of the carburetor main body 3 for movable connection; the first step 43 that mates with the axial direction disengagement prevention portion 621 of the high speed-side limit cap 6 to prevent disengagement of the high speed-side limit cap 6; the first step portion 42 positioned in front and back of the first step 43, has a larger diameter than the first step 43 on a tip side, and forms a step; the second step portion 44 that has a larger diameter than the first step 43 on a base-end side and forms a step; a second step 45 that is more on the base-end side than the second step portion 44 and is positioned between the valve-side locking portion 47; a seal portion 46 that is positioned further on the base-end side than the screw portion 41 and is for preventing unintended outflow of the fuel from the high speed-side adjustment hole 81 to the outside; the valve-side locking portion 47 provided with a locking means for mating with the cap-side locking portion 623 of the high speed-side limit cap 6; and a needle valve 48 for adjusting the fuel flow rate by increasing and decreasing the effective surface area of the high speed-side fuel channel 9.

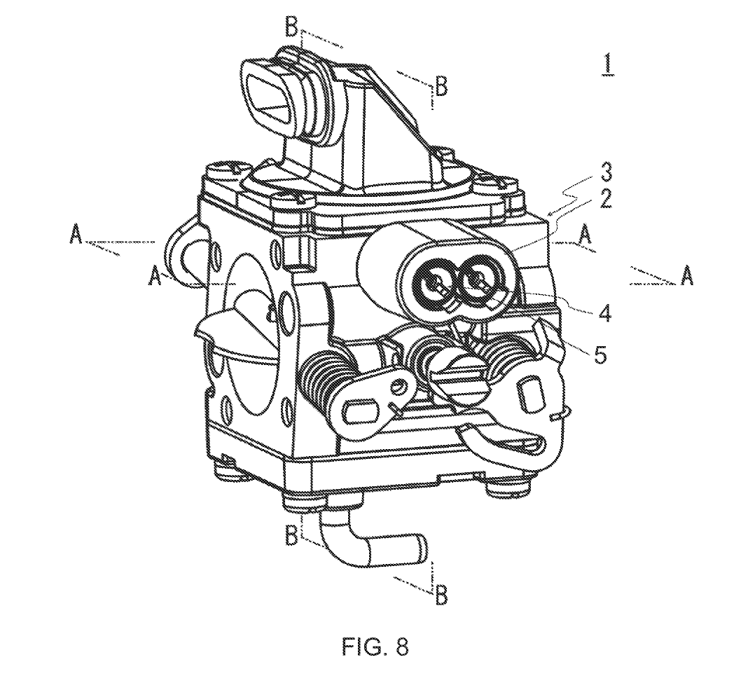

FIG. 8 is a perspective view illustrating the carburetor 1 in the embodiment of the present invention.

The carburetor 1 has the carburetor main body 3 that includes the high speed-side fuel channel 9 and the low speed-side fuel channel 8; the high speed-side adjustment hole 91 and a low speed-side adjustment hole 81 provided near each other on the carburetor main body 3 in communication with each fuel channel 9, 8; the high speed-side adjustment valve 4 and the low speed-side adjustment valve 5 movably connected by being screwed into each adjustment hole 91, 81 for individually manually adjusting the effective surface areas of the high speed-side fuel channel 9 and the low speed-side fuel channel 8; the high speed-side limit cap 6 and the low speed-side limit cap 7 that are connected as the control means to the high speed-side adjustment valve 4 and the low speed-side adjustment valve 5 and have the arm pieces 611, 711 for limiting the rotation ranges by being disposed protruding in the circumferential direction to contact the other component; and the sleeve 2 that is disposed in the position surrounding the outer periphery of each limit cap 6, 7 that covers each adjustment valve 4, 5 and is integrally connected to the carburetor main body 3.

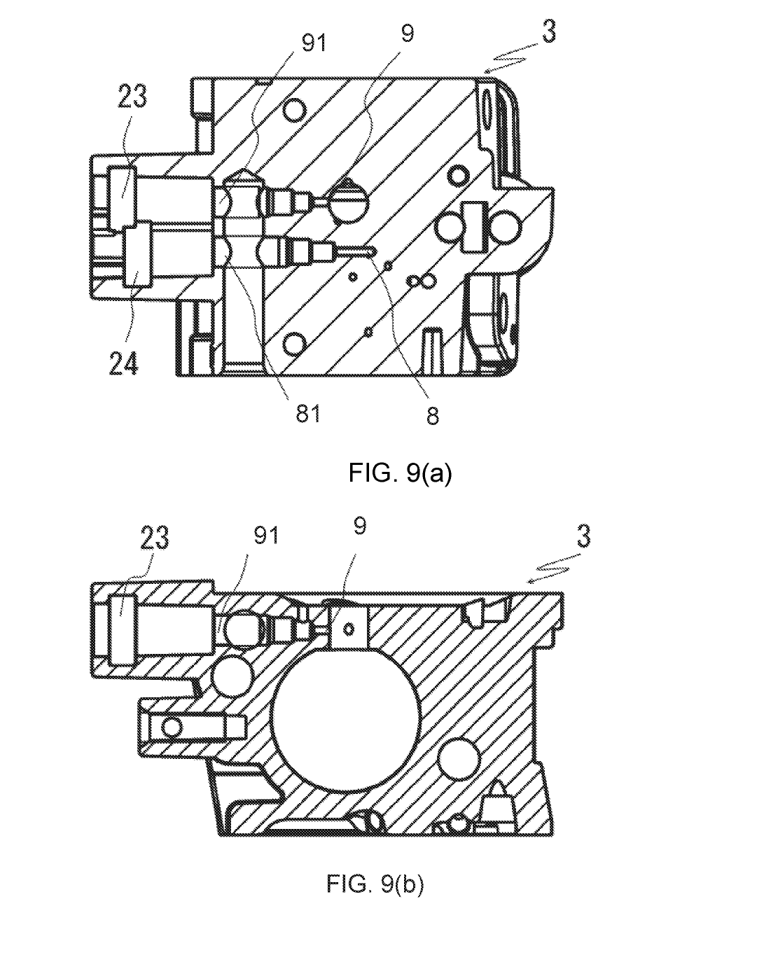

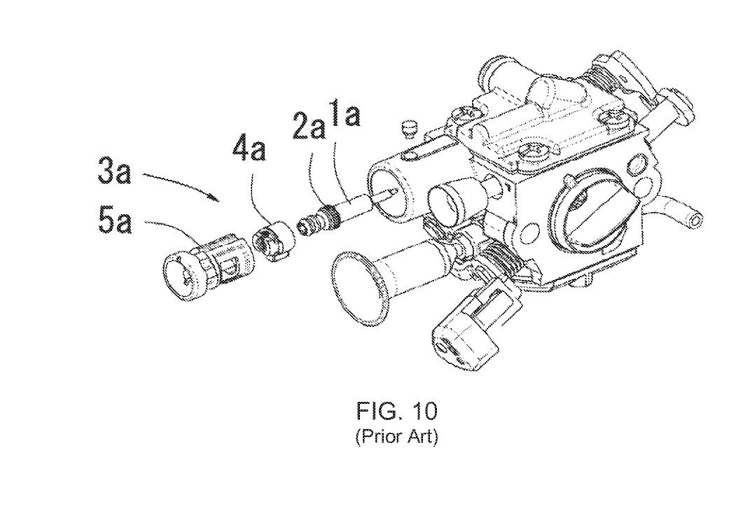

FIGS. 9(a) and (b) are partial cross-sectional views illustrating the structure of the carburetor 1 and the sleeve 2 that extends from the carburetor 1 or is formed as a separate body and integrally connected thereto in the embodiment of the present invention. FIG. 9(a) is a partial cross-sectional view along plane A illustrated in FIG. 8, and FIG. 9(b) is a partial cross-sectional view along plane B illustrated in FIG. 8.

All features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. Express recitation of every possible combination and substitution is overly burdensome, especially given that the permissibility of each and every such combination and substitution will be readily recognized by those of ordinary skill in the art upon reading this description.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic) intervening entities) and the indirect coupling of two entities (with one or more non-negligible intervening entities). Where entities are shown as being directly coupled together, or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

### REFERENCE NUMBERS LIST

1 Carburetor
2 Sleeve
3 Carburetor main body
4 High speed-side adjustment valve
5 Low speed-side adjustment valve
6 High speed-side limit cap
7 Low speed-side limit cap
8 Low speed-side fuel channel
9 High speed-side fuel channel
10 Other component
11 Adjustment valve where shape of portion is different
21 High speed-side limit cap positioning groove
22 Low speed-side limit cap positioning groove
23 High speed-side rotation space
24 Low speed-side rotation space
25 High speed-side limit cap rotatable range
26 Low speed-side limit cap rotatable range
41 Screw portion
42 First step portion
43 First step
44 Second step portion
45 Second step
46 Seal portion
47 Valve-side locking portion
48 Needle valve
51 Screw portion
52 First step portion
53 First step
54 Second step portion
55 Second step
56 Seal portion
57 Valve-side locking portion
58 Needle valve
61 High speed-side limit cap tip portion
611 Arm piece
612 Through hole
613 User adjustment hole
614 Window hole
62 High speed-side limit cap base end portion
621 Axial direction disengagement prevention portion
622 Through hole
623 Cap-side locking portion
624 Flange
625 Opening portion
71 Low speed-side limit cap tip portion
711 Arm piece
712 Through hole
713 User adjustment hole
714 Window hole
72 Low speed-side limit cap base end portion
721 Axial direction disengagement prevention portion
722 Through hole
723 Cap-side locking portion
724 Flange
725 Opening portion
81 Low speed-side adjustment hole
91 High speed-side adjustment hole

### CITATION LIST

[1] Japanese Examined Patent Application Publication No. S47-42424

[2] U.S. Pat. No. 3,618,906

[3] Japanese Unexamined Utility Model (Registration) Application Publication No. S61-134555

[4] U.S. Pat. No. 5,236,634

[5] Japanese Unexamined Patent Application Publication No. H8-312465

[6] Japanese Unexamined Patent Application Publication No. 2009-138652

[7] U.S. Pat. No. 8,544,829

1. A carburetor for supplying fuel to a utility engine comprising:
a carburetor main body that has a high speed-side fuel channel and a low speed-side fuel channel;
a high speed-side adjustment hole and a low speed-side adjustment hole provided adjacent each other in the carburetor main body in communication with each fuel channel;
a high speed-side adjustment valve and a low speed-side adjustment valve movably connected in an axial direction by being screwed in each adjustment hole for individually manually adjusting effective surface areas of the high speed-side fuel channel and the low speed-side fuel channel;
a high speed-side limit cap and a low speed-side limit cap including
a cap side locking portion connected as a control means to a valve-side locking portion provided on the high speed-side adjustment valve and the low speed-side adjustment valve for integral operation in a circumferential direction of the high speed-side adjustment valve and the low speed-side adjustment valve by mating with the valve-side locking portion,
an axial direction disengagement prevention portion for integrating an operation in an axial direction by mating in an axial direction with a first step or a second step of the high speed-side adjustment valve and the low speed-side adjustment valve, and
an arm piece that is disposed protruding in a circumferential direction and limits a rotation range by contacting another component; and
a sleeve that is disposed in a position surrounding an outer periphery of each limit cap covering each adjustment valve and integrally connected to the carburetor main body;
the sleeve comprising:
a rotation space formed in a cylindrical shape for the arm piece to rotate in the sleeve; and
a limit cap positioning groove in communication with the rotation space from a surface of the sleeve and enabling movement of each limit cap to a position in a second state, by inserting the arm piece therethrough, the limit cap position groove being formed in a shape that prevents rotation of each limit cap in the circumferential direction when each limit cap is in a position of a first state.

2. The carburetor according to claim 1, wherein either the high speed-side limit cap or the low speed-side limit cap is replaced with another component where at least a portion thereof has the substantially same outer diameter as an outer diameter of the high speed-side limit cap or the low speed-side limit cap, the arm piece of the high speed-side limit cap or the low speed-side limit cap abutting the other component and limiting the rotation range of the adjustment valve connected to the high speed-side limit cap or the low speed-side limit cap.

3. The carburetor according to claim 1, wherein either the high speed-side limit cap or the low speed-side limit cap is coupled to one of the high speed-side adjustment valve and the low speed-side adjustment valve and at least a portion of the other adjustment valve having substantially the same outer diameter as the outer diameter of the high speed-side limit cap or the low speed-side limit cap, the arm piece of the high speed-side limit cap or the low speed-side limit cap abutting the other adjustment valve and limiting the rotation range of the adjustment valve connected to the high speed-side limit cap or the low speed-side limit cap.

4. The carburetor according to claim 2, wherein either the high speed-side limit cap or the low speed-side limit cap is coupled to one of the high speed-side adjustment valve and the low speed-side adjustment valve and at least a portion of the other adjustment valve having substantially the same outer diameter as the outer diameter of the high speed-side limit cap or the low speed-side limit cap, the arm piece of the high speed-side limit cap or the low speed-side limit cap abutting the other adjustment valve and limiting the rotation range of the adjustment valve connected to the high speed-side limit cap or the low speed-side limit cap.

5. The carburetor according to claim 3, wherein the high speed-side limit cap and the low speed-side limit cap include a tip portion and a base end portion.

6. The carburetor according to claim 4, wherein the high speed-side limit cap and the low speed-side limit cap include a tip portion and a base end portion.

7. The carburetor according to claim 5, wherein the tip portion and the base end portion are constructed from one of a metal and a plastic.

8. The carburetor according to claim 6, wherein the tip portion and the base end portion are constructed from one of a metal and a plastic.

9. The carburetor according to claim 1, wherein the sleeve is formed as a separate body from the carburetor main body.

10. The carburetor according to claim 2, wherein the sleeve is formed as a separate body from the carburetor main body.

11. The carburetor according to claim 3, wherein the sleeve is formed as a separate body from the carburetor main body.

12. The carburetor according to claim 4, wherein the sleeve is formed as a separate body from the carburetor main body.

13. The carburetor according to claim 1, wherein the rotation space is provided to occupy a cylindrical range that is a trajectory drawn by each arm piece when they rotate about an axis of each limit cap when the high speed-side limit cap and the low speed-side limit cap are each in the second state.

14. The carburetor according to claim 2, wherein the rotation space is provided to occupy a cylindrical range that is a trajectory drawn by each arm piece when they rotate about an axis of each limit cap when the high speed-side limit cap and the low speed-side limit cap are each in the second state.

15. The carburetor according to claim 3, wherein the rotation space is provided to occupy a cylindrical range that is a trajectory drawn by each arm piece when they rotate about an axis of each limit cap when the high speed-side limit cap and the low speed-side limit cap are each in the second state.

16. The carburetor according to claim 4, wherein the rotation space is provided to occupy a cylindrical range that is a trajectory drawn by each arm piece when they rotate about an axis of each limit cap when the high speed-side limit cap and the low speed-side limit cap are each in the second state.

17. The carburetor according to claim 1, wherein the rotation space and the limit cap positioning groove are molded when forming the sleeve.

18. The carburetor according to claim 2, wherein the rotation space and the limit cap positioning groove are molded when forming the sleeve.

19. The carburetor according to claim 3, wherein the rotation space and the limit cap positioning groove are molded when forming the sleeve.

20. The carburetor according to claim 4, wherein the rotation space and the limit cap positioning groove are molded when forming the sleeve.
